(19) United States
(12) Patent Application Publication
(10) Pub. No.: US 2013/0254281 A1
(43) Pub. Date: Sep. 26, 2013

(54) COLLABORATIVE MEDIA GATHERING SYSTEMS AND METHODS

(71) Applicants: Wei Sun, San Jose, CA (US); Yi Wu, San Jose, CA (US); Maha El Choubassi, Beirut (LB); Joshua Ratcliff, San Jose, CA (US); Michelle X. Gong, Sunnyvale, CA (US)

(72) Inventors: Wei Sun, San Jose, CA (US); Yi Wu, San Jose, CA (US); Maha El Choubassi, Beirut (LB); Joshua Ratcliff, San Jose, CA (US); Michelle X. Gong, Sunnyvale, CA (US)

(21) Appl. No.: 13/428,166

(22) Filed: Mar. 23, 2012

(51) Int. Cl. G06F 15/16

(52) U.S. Cl. 709/204

(57) ABSTRACT

Systems, devices and methods are described including determining a goal for collaborative media gathering, automatically generating a plurality of tasks specifying the capture of media associated with the goal, storing the tasks, and providing the tasks to a plurality of users. The goal may be automatically determined in response to real-time social media analysis.

### BACKGROUND

Presently, most hand-held devices, including cell phones, tablet computers and the like, incorporate media capture tools such as video capable cameras and microphones. However, some key aspects of media capture, including the capturing and sharing of video or still images as well as audio data, are still mostly the result of isolated activities involving individuals capturing the media on their own without coordination with other individuals. This may make it difficult, for instance, for a group of botanists to coordinate their efforts to cover various categories of trees or flowers and eventually produce a report on a single topic or on several topics, for multiple journalists to coordinate coverage of a news event, or for family members visiting an exhibition or a theme park to collaborate on memorializing their visit with video and/or still images, to name a few examples.

Although individuals may subsequently share their captured media via social networking sites in an ad hoc manner, there is no existing automated mechanism to coordinate the shared or collaborative capturing of media to achieve a common objective or goal. For example, a group of individuals may wish to coordinate their efforts to capture images of a particular event even though they may or may not know each other, may be in different locations, and/or may capture their images at different times. Although some conventional approaches attempt to achieve coordination through shared mass media, they do not allow for a seamless, real-time, interactive capture and sharing experience and do not provide feedback between media capture and group effort for achieving a common goal.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example collaborative media gathering system;

FIG. 2 is an illustrative diagram of portions of the system of FIG. 1;

FIG. 3 is a flow diagram illustrating an example process;

FIG. 4 is an illustrative diagram of another example collaborative media gathering system;

FIG. 5 is an illustrative diagram of an example system; and

FIG. 6 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

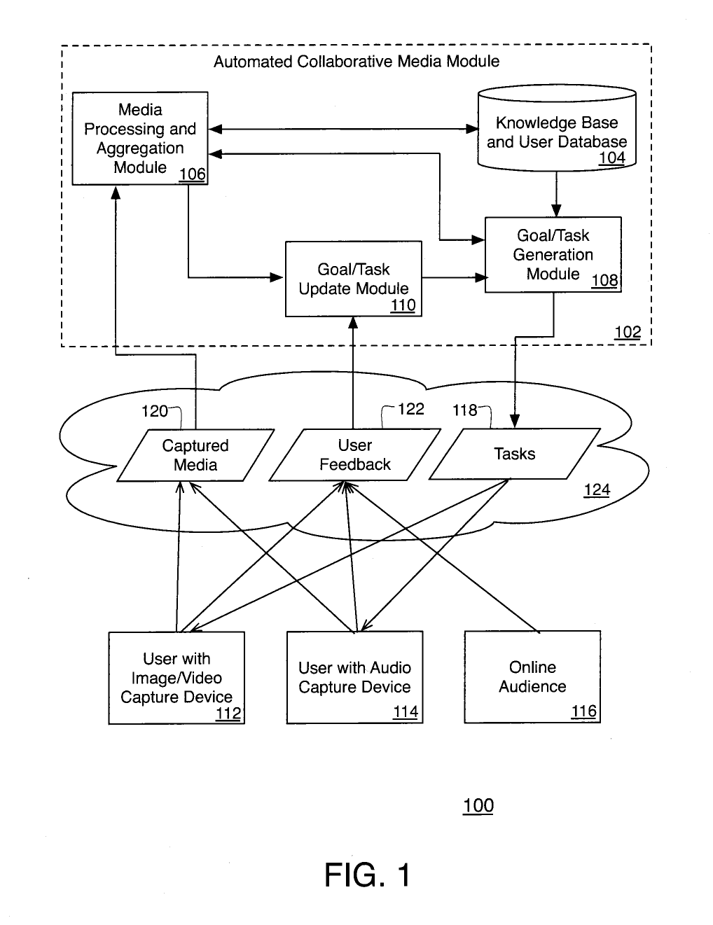

FIG. 1 illustrates an example collaborative media gathering system 100 in accordance with the present disclosure. As will become apparent in light of the remainder of the present disclosure, system 100 may, when in operation, be configured to allow for seamless, real-time, interactive media gathering including media capture and sharing while providing for feedback between media capture and group effort for achieving one or more common goals. System 100 includes an automated collaborative media (ACM) module 102, a network 124 and multiple users 112-116. ACM module 102 includes a knowledge base and user database 104, a media processing and aggregation module 106 coupled to knowledge base and user database 104, a goal/task generation module 108 coupled to knowledge base and user database 104 and to media processing and aggregation module 106, and a goal/task update module 110 coupled to goal/task generation module 108.

In various implementations, when operational, the various components of ACM module 102 may interact in real-time with multiple users to facilitate collaborative media schemes in accordance with the present disclosure. In the example of FIG. 1, ACM module 102 interacts with multiple users including a first user 112 equipped with an image and/or video capture device (not separately depicted in FIG. 1) such as a video capable smart phone, a second user 114 equipped with an audio capture device (also not separately depicted in FIG. 1) such as a smart phone incorporating a microphone and an audio capture application, and a third user 116 corresponding to an online audience who is not participating in media capture in the field but following one or more particular events on the internet. Users 112-116 are depicted herein for the purposes of illustration and are not intended to represent all possible users or to limit the present disclosure to any particular types or number of users equipped with any particular types or number of capture devices. Further, as used herein the term “user” refers to both a human being and to the capture device employed by the human being when interacting with ACM module 102.

In various implementations, as will be explained in greater detail below, ACM module 102 may interact with users 112-114 via tasks 118 assigned and/or advertised to users 112-114 by goal/task generation module 108. ACM module 102 may also receive captured media 120 uploaded by and provided to media processing and aggregation module 106 by users 112-114. Further, ACM module 102 may receive user feedback 122 uploaded by and provided to goal/task update module 110 by users 112-116. Wired and/or wireless network 124 may provide communication of tasks 118, captured media 120 and user feedback 122 between ACM module 102 and users 112-116 using any known wired and/or wireless networking techniques, devices and/or systems.

Media capture devices (not shown) employed by users 112 and 114 may include a camera (still and/or video), global positioning system (GPS) functionality, one or more orientation sensors, networking capability, data storage capability, processors (e.g., a central processing unit (CPU), a digital signal processing (DSP) unit, a graphics processing unit (GPU), and/or media processor, etc.) to provide for the capture, processing and/or rendering, etc., of media content. In addition to capturing media (e.g., images) the capture devices employed by users 112 and 114 may also obtain media metadata including, but not limited to, time, location, elevation, camera orientation, environment temperature, user emotions, and so forth. Captured media 120 may include such media metadata that may be used by ACM module 102 for media processing and/or aggregation.

In various embodiments, ACM module 102 may be implemented by software instructions executed by logic such as one or more processor cores provided by one or more computing devices such as one or more servers or the like. One or more cloud server may be utilized to coordinate the media capture effort. For example, one or more cloud server(s) may implement ACM module 102 and may advertise or assign tasks 118 by pushing corresponding task information onto the capture devices of users 112-114. However, the present disclosure is not limited in this regard and ACM module 102 may be implemented by any combination of hardware, firmware and/or software.

As used herein the term “goal” refers to a common objective to be achieved by capturing media. For instance, a goal may be to capture visual media of a particular scene or event using, for example, image placement, image panorama creation, or 3D model creation. A goal may also be to perform a particular study or trip report, or to cover a particular news event. In general, a goal may be any common objective for which media (still images, video, audio, etc.) may be collaboratively captured by a group of users. As used herein the term “task” refers to an assignment to capture media that is needed, at least in part, to achieve a goal. In general, multiple tasks may be associated with a single goal. Tasks may be assigned or advertized to users, and subsequent completion of the tasks may be associated with achieving the goal. Further, as used herein, a task “attribute” refers to any information associated with a task including, but not limited to, a task objective, a task time, a task location, skill(s) and/or equipment needed to complete a task, and so forth.

For instance, in a non-limiting example, a goal for a group of botanical researchers (who may not reside in the same location) may be to undertake a botanic field study by capturing images of various plants in a particular geographic region. In this example, the tasks needed to achieve the goal may specify that images are to be captured for defined times, locations, and/or specific plants. Of course, this is just one non-limiting example provided herein to illustrate the usage of various terms and many additional example implementations are possible consistent with the present disclosure.

As will be explained in greater detail below, in various implementations, tasks and/or goals may be determined by a user of system 100 (e.g., one of users 112-116) based on user feedback 122 or may be automatically generated by ACM module 102. Further, a super-user or system master (not shown) of system 100 may determine tasks and/or goals and instruct ACM module 102 accordingly.

As will be explained in greater detail below, in implementations where ACM module 102 automatically generates goals and/or tasks, ACM module 102 may employ real-time analysis of live social media (e.g., Facebook®, Twitter®, Google+® and the like), news feeds (e.g., Rueters®, AP®, and so forth) and the like to determine important media capture events for which tasks/goals may be auto-generated. To do so, ACM module 102 may employ known techniques in speech, natural language, image, and/or pattern analysis to identify social and/or news trends and thereby goals and/or tasks.

Further, as will also be explained in greater detail below, in various implementations, goals and/or tasks may be either pre-defined or dynamically generated on-the-fly (e.g., by one or more of users 112-116 or by ACM module 102). In addition to following a set of pre-defined rules, users may also determine goals and/or tasks based on their own interests, personal goals, schedules, convenience, etc. When new circumstances occur, users may generate new tasks, set new goals or even define a new collaborative project.

In various implementations, the tasks needed to achieve a goal may be relatively well defined. For instance, with regard to the example of the botanic study goal provided immediately above, the associated tasks may be well defined with respect to specific task attributes of objective, time, location and/or objects to be imaged (e.g., capture still image of plant X). In other implementations, the tasks needed to achieve a goal may be relatively vague. For example, when a group of photojournalists decide to cover the news of an earthquake that just occurred, they may not know exactly what aspects to cover and what location each photojournalists should go to and, hence, the corresponding tasks may be vague (e.g., “capture human interest images”).

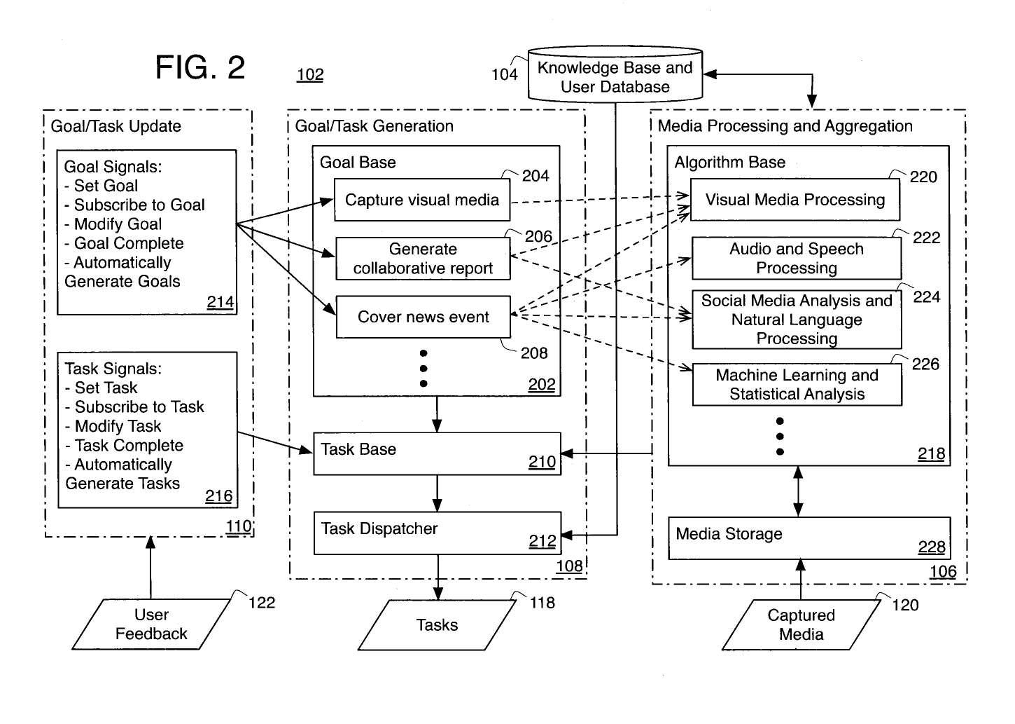

FIG. 2 depicts ACM module 102 in greater detail in accordance with the present disclosure. As shown in FIG. 2, goal/task generation module 108 includes a goal base 202 containing various goals 204-208, a task base 210 to store tasks related to one or more of goals 204-208, and a task dispatcher 212 that retrieves tasks 118 from task base 210 and that assigns or advertises tasks 118 to users in response to user profile information obtained from user database 104. Goals 204-208 may be generated and/or updated in response to various goal signals 214 received from goal/task update module 110. Further, tasks stored in task base 212 may be generated and/or updated in response to various task signals 216 received from goal/task update module 110 and/or provided by media processing and aggregation module 106 when system 100 automatically generates tasks.

In various implementations, knowledge base 104 may store and provide information on specific topics (e.g. various plants growing in spring time in a specific geographic location), or news events from live news feed (e.g. an earthquake just occurred in a specific geographic location), or information from other sources. User database 104 may include profile information for users 112-114 who have signed up for one or more collaborative media gathering events. User profile information stored in database 104 may include a user's time schedule, geographical location, personal interests, various skills, and so forth.

In response to the knowledge base information and user profile data stored in knowledge base and user database 104, goal/task generation module 108 may generate specific media capture tasks 118 based on the time and location each task is to be performed, and the objective of each task (e.g., in the case of botanical study, what plant to capture, which part of the plant (trunk, branch, leaves, flowers, fruits, etc.) is interesting to the study, and so forth). Goal/task generation module 108 may also generate a vague task, for example, in the case of an earthquake, to cover news of the event by capturing pictures.

Media processing and aggregation module 106 includes an algorithm base 218 containing various media processing and/or analysis algorithms 220-226, and media storage 228 that receives and stores captured media 120. As shown in FIG. 2, depending on the nature of the various goals 204-208 of goal/task generation module 108, module 108 may utilize one or more of known algorithms 220-226 of media processing and aggregation module 106 to automatically generate and/or modify tasks contained in task base 210.

In various implementations, goal/task generation module 108 may receive a “set goal” control signal that may come from a super-user or system master directly, or from user feedback 122 obtained via goal/task update module 110, or automatically generated by media processing and aggregation module 106 via one or more of algorithms 220-226. To do so, a set goal signal may activate associated algorithms stored in the algorithm base 218. For example, if “cover a news event” is provided or set in a set goal signal, the set goal signal may activate visual media processing algorithm(s) 220 (e.g. panorama stitching, 3D reconstruction), audio and speech processing algorithm(s) 222, social media analysis and natural language processing algorithm 224, and machine learning and statistical analysis algorithm 226.

Depending upon the activated media processing algorithm(s), information from knowledge base 104, and additional attributes provided in the “set goal” signal may be combined together to generate initial tasks that may be stored in task base 210 of goal/task generation module 108. For example, a set goal signal may specify a goal to be the capturing of images of a certain place or a certain event at a certain time. Goal/task generation module 108 may then collect the time and spatial information provided by the set goal signal, use the spatial information to retrieve from knowledge base 104 the geographic information of the specified place or building plans, use the visual media processing algorithm 220 to determine one or multiple best starting locations and orientations for media capture, and finally produce initial tasks 118, such as capture pictures at a specific geo-location at/during a specific time.

In various implementations, task dispatcher 212 matches the attributes of each task (including time, location, required skill or equipment, etc.) against the attributes of each user (including availability, location, skill level, etc.) based on information from user database 104 to produce user candidates for each task. In various implementations, task dispatcher 212 may then assign the task to a candidate user or may announce it to multiple candidate users. Each candidate user may subscribe to one or more tasks 118 by sending user feedback 122 to ACM module 102 via network 124 where that feedback may be used to update task base 210 accordingly.

Once media is captured in response to a task and is uploaded as captured media 120, media processing and aggregation module 106 may analyze, aggregate and/or process the media and may update task base 210 accordingly. For instance, a user's media may be processed and aggregated with other users' uploaded media to produce a combined output such as a photo album, a media report, a movie, and so forth. Module 106 may perform aggregation of captured media 120 by mapping out the media using media metadata such as time, geo-location, people, and/or activities recorded in the media, and/or by stitching related media into a big panorama image, or by merging related media to reconstruct a 3D model of the captured scene, etc. Aggregation undertaken by module 106 may also use past knowledge retrieved from knowledge base 104 to aid in current aggregation. The final output of media aggregation undertaken by module 106 may be used to update and improve the information contained in knowledge base 104.

Based on processing results, module 106 may create new tasks for collecting media due, for example, to media being incomplete or of poor quality. For example, visual media processing algorithm 220 (e.g. a 3D reconstruction algorithm) may decide that it does not have enough data to reconstruct part of a scene based on processing results. Therefore, in this example, algorithm 220 may create new tasks for capturing additional pictures of that part of the scene suggesting different locations and/or angles. In general, media processing and aggregation module 106 may update task base 210 by adding a new task, modifying an existing task, or marking a task completed.

In various implementations, a user who participates in media capture in the field (e.g., user 112 or user 114) and a user who is following a particular event online (e.g., user 116) may also update task base 210 by sending various task signals 216 (e.g., set a new task, modify task, task complete, etc.) via user feedback 122 to goal/task update module 110. A user may also update goal base 202 by sending various goal signals 214 (e.g., set a new goal, modify goal, goal complete, etc.) via user feedback 122. If a user wishes to add a new goal to base 202 and if there are no pre-registered processing algorithms for the new goal, that user may provide associated processing algorithms to be registered with media processing and aggregation module 106.

In various implementations, referring also to FIG. 1, when system 100 is in operation, ACM 102 may send tasks 118 to users 112-114 and may receive captured media 120 and user feedback 122 using network 124 in either client/server fashion or peer-to-peer fashion. Thus, in some implementations, one or more cloud servers may implement ACM module 102 and may advertise or assign tasks 118 by pushing the associated task information (e.g., task attributes) onto capture devices of users 112-114.

If one of users 112-114 agrees to take a task, he/she may indicate so by, for example, selecting a “Yes” button in a user interface appearing on the user's capture device and thereby providing user feedback 122. Upon receiving the corresponding feedback 122 from that user via goal/task update module 110, goal/task generation module 108 may record the assigned task and the associated user and may update task base 210 accordingly. Once media capture is completed by the user, captured media 120 and associated media meta data may be uploaded from the user's capture devices to media processing and aggregation module 106.

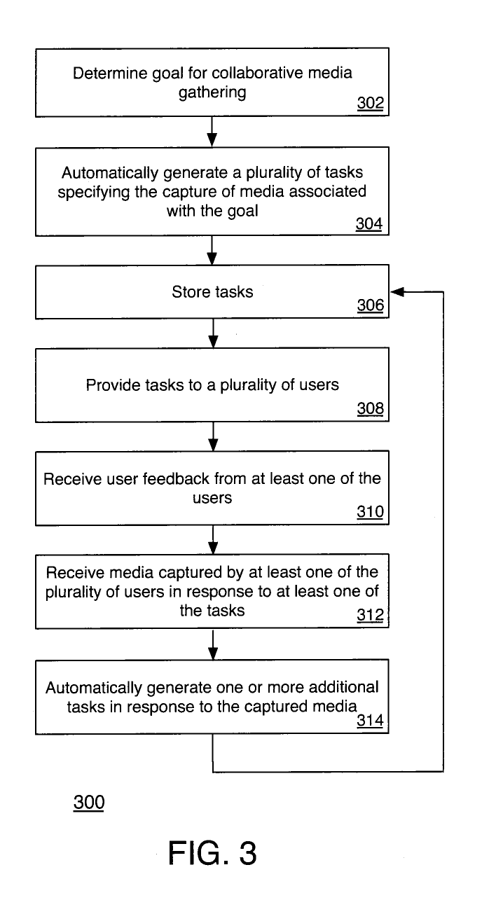

FIG. 3 that illustrates a flow diagram of an example process 300 according to various implementations of the present disclosure. Process 300 may include one or more operations, functions or actions as illustrated by one or more of blocks 302, 304, 306, 308, 310, 312 and 314 of FIG. 3. By way of non-limiting example, process 300 will be described herein with reference to system 100 and ACM module 102 of FIGS. 1 and 2.

Process 300 may begin at block 302 where a goal may be determined for collaborative media gathering. In various implementations, at least one of users 112-116 may provide a set goal signal via feedback 122 to determine a goal at block 302. In other implementations, a goal may be determined automatically at block 302 based, at least in part, on real-time social media analysis. For example, social media analysis undertaken at block 302 may include simple queries (e.g., number of tweets per hour) or may employ known machine learning and language processing techniques to answer more complicated queries (e.g., “based on search results and the language used on facebook® updates: what information are people asking for?”). The results of such queries may be sorted into pre-defined categories (e.g., interviews, photos, panoramic videos, etc.). Such queries may also be influenced by the specific demands of contributors who want to improve the content.

In various implementations, goal/task generation module 108 may employ one or more algorithms in base 218 of media processing and aggregation module 106 to implement goal determination logic when undertaking block 302. An example of goal determination logic employed at block 302 may include: (1) obtain latest AP®/Reuters® news updates by geographic region; (2) assign priority based on number of Twitter® tweets (e.g., is this breaking news popular?); (3) perform linguistic analysis (using algorithm 224) on Twitter® feeds to determine what online viewers want to know; (4) if the results of items (1)-(3) meets one or more thresholds of interest and importance, then (a) determine whether more text interviews are desired (e.g., using rules or machine learning algorithm 226), (b) determine if there are presently too few photos, videos, or text, and set a goal to acquire more corresponding media; (5) honor any special user requests provided via feedback 122.

At block 304, a plurality of tasks may be automatically generated where the tasks specify the capture of media associated with the goal determined at block 302. For example, as described previously, goal/task generation module 108 may employ one or more algorithms in base 218 of media processing and aggregation module 106 to automatically generate tasks at block 304. For instance, the tasks generated at block 304 may instruct users to begin taking photos at different angles in the same area to obtain the goal of a panorama image. As any given users complete a task, further tasks in task base 210 may be given to them to complete. In various examples, the tasks generated at block 304 may include “go to XYZ GPS coordinates”, “capture an image in XYZ direction”, etc.

Process 300 may continue at block 306 where the tasks may be stored and block 308 where the tasks may be provided to a plurality of users. For instance, block 306 may involve storing the tasks in task base 210 and block 308 may involve task dispatcher 212 providing tasks 118 to users 112-114 as described previously.

At block 310, user feedback may be received. For instance, as described previously, user feedback 122 may be provided to goal/task update module 110 where feedback 122 may include various goal signals 214 and/or task signals 216 as described previously. For example, in response to a task, a user may indicate that the task has been completed using a “task complete” signal provided in feedback 122. In general, feedback received at block 310 may specify at least one of a current status of at least one task being performed by the user, one or more additional tasks to be associated with the goal, or a modification to be applied to one or more of the tasks. The user feedback may be received in real-time over network 124. In various implementations, finished tasks may be accepted as-is, or their evaluation might be voted on by viewers online, e.g., online audience 116, along with comments for the collaborating users such as “good work!”, etc. Further, online audience 116 may provide feedback 122 including, for example, a new task such as “ask her about XYZ”.

At block 312, media captured by at least one of the plurality of users in response to at least one of the tasks may be received. For instance, a task generated at block 304 may instruct user 112 to capture an image of a certain object and block 312 may involve the user uploaded the captured image to media processing and aggregation module 106 as captured media 120.

Process 300 may continue at block 314 where one or more additional tasks may be generated in response to the captured media received at block 312. For instance, as described previously, media processing and aggregation module 106 may process the media received at block 312 and may determine that one or more additional tasks are required. For example, visual media processing algorithm 220 (e.g. a 3D reconstruction algorithm) may decide that it does not have enough data as received at block 312 to reconstruct part of a scene based on processing results. Therefore, in this example, algorithm 220 may create new tasks at block 314 for capturing additional pictures of that part of the scene suggesting different locations and/or angles. In general, media processing and aggregation module 106 may update task base 210 by adding a new task, modifying an existing task, or marking a task completed. Process 300 may continue to block 306 to store tasks generated at 314.

While implementation of example process 300, as illustrated in FIG. 3, may include the undertaking of all blocks shown in the order illustrated, the present disclosure is not limited in this regard and, in various examples, implementation of process 300 may include the undertaking only a subset of the blocks shown and/or in a different order than illustrated.

In addition, any one or more of the blocks of FIG. 3 may be undertaken in response to instructions provided by one or more computer program products. Such program products may include signal bearing media providing instructions that, when executed by, for example, a processor, may provide the functionality described herein. The computer program products may be provided in any form of machine-readable medium. Thus, for example, a processor including one or more processor core(s) may undertake one or more of the blocks shown in FIG. 3 in response to program code and/or instructions or instruction sets conveyed to the processor by a machine-readable medium. In general, a machine-readable medium may convey software in the form of program code and/or instructions or instruction sets that may cause any of the devices and/or systems described herein to implement at least portions of automatic media gathering systems 100.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

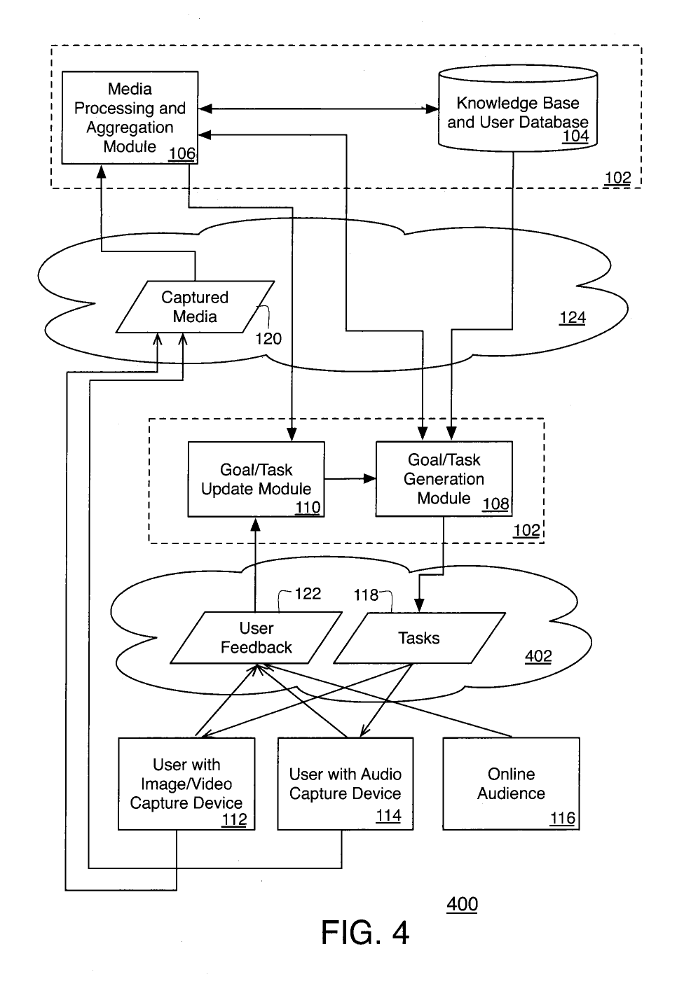

FIG. 4 illustrates another example collaborative media gathering system 400 in accordance with the present disclosure. System 400 is similar to system 100 of FIG. 1 except that the capture device of one or more of users 112-114 may implement portions of ACM module 102, and the capture devices of users 112-114 may employ a local ad-hoc or peer-to-peer (P2P) network 402 to coordinate media capture. For example, the capture device of user 112 may implement goal/task update module 110 and goal/task generation module 108 while P2P network 402 may facilitate the communication of user feedback 122 and tasks 118 among users 112-116. Upon completion of a task, captured media 120 may be uploaded to and aggregated by media processing and aggregation module 106 and a corresponding task complete signal may be supplied to goal/task generation module 108.

Systems 100 and 400 represent only two examples of automatic media gathering systems in accordance with the present disclosure and many additional system configurations are possible. For instance, in addition to implementing goal/task update module 110 and goal/task generation module 108, a user's capture device may also implement additional components of ACM module 102 including media processing and aggregation module 106 and/or knowledge base and user database 104.

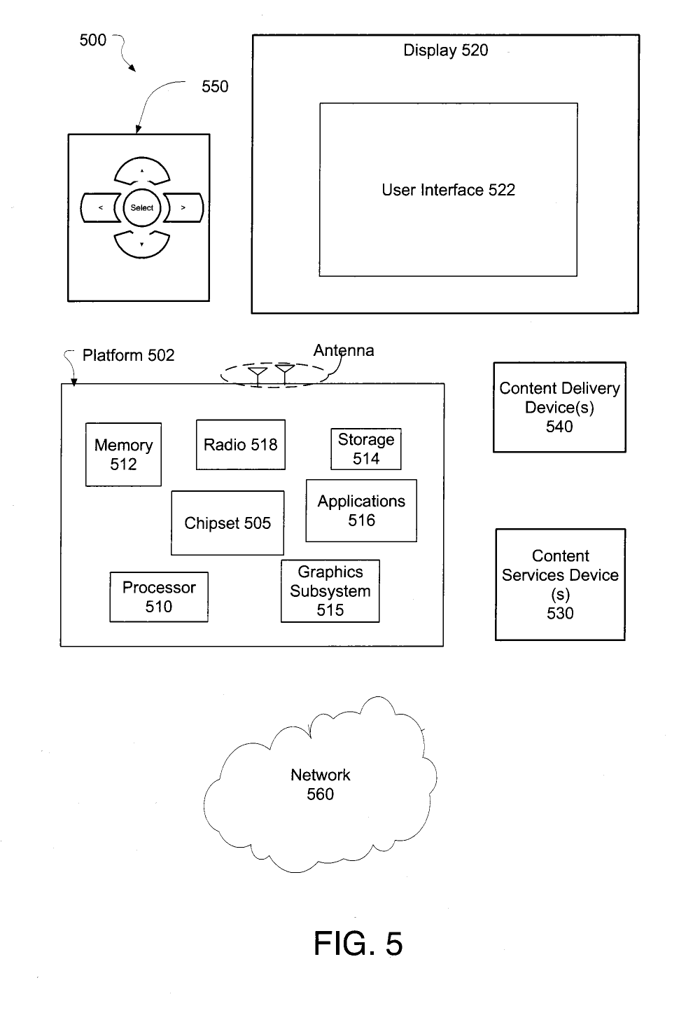

FIG. 5 illustrates an example system 500 in accordance with the present disclosure. In various implementations, system 500 may be a media system although system 500 is not limited to this context. For example, system 500 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 500 includes a platform 502 coupled to a display 520. Platform 502 may receive content from a content device such as content services device(s) 530 or content delivery device(s) 540 or other similar content sources. A navigation controller 550 including one or more navigation features may be used to interact with, for example, platform 502 and/or display 520. Each of these components is described in greater detail below.

In various implementations, platform 502 may include any combination of a chipset 505, processor 510, memory 512, storage 514, graphics subsystem 515, applications 516 and/or radio 518. Chipset 505 may provide intercommunication among processor 510, memory 512, storage 514, graphics subsystem 515, applications 516 and/or radio 518. For example, chipset 505 may include a storage adapter (not depicted) capable of providing intercommunication with storage 514.

Processor 510 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 510 may be dual-core processor(s), dual-core mobile processor(s), and so forth.

Memory 512 may be implemented as a volatile memory device such as, but not limited to, a Random Access Memory (RAM), Dynamic Random Access Memory (DRAM), or Static RAM (SRAM).

Storage 514 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 514 may include technology to increase the storage performance enhanced protection for valuable digital media when multiple hard drives are included, for example.

Graphics subsystem 515 may perform processing of images such as still or video for display. Graphics subsystem 515 may be a graphics processing unit (GPU) or a visual processing unit (VPU), for example. An analog or digital interface may be used to communicatively couple graphics subsystem 515 and display 520. For example, the interface may be any of a High-Definition Multimedia Interface, DisplayPort, wireless HDMI, and/or wireless HD compliant techniques. Graphics subsystem 515 may be integrated into processor 510 or chipset 505. In some implementations, graphics subsystem 515 may be a stand-alone card communicatively coupled to chipset 505.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 518 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 518 may operate in accordance with one or more applicable standards in any version.

In various implementations, display 520 may include any television type monitor or display. Display 520 may include, for example, a computer display screen, touch screen display, video monitor, television-like device, and/or a television. Display 520 may be digital and/or analog. In various implementations, display 520 may be a holographic display. Also, display 520 may be a transparent surface that may receive a visual projection. Such projections may convey various forms of information, images, and/or objects. For example, such projections may be a visual overlay for a mobile augmented reality (MAR) application. Under the control of one or more software applications 516, platform 502 may display user interface 522 on display 520.

In various implementations, content services device(s) 530 may be hosted by any national, international and/or independent service and thus accessible to platform 502 via the Internet, for example. Content services device(s) 530 may be coupled to platform 502 and/or to display 520. Platform 502 and/or content services device(s) 530 may be coupled to a network 560 to communicate (e.g., send and/or receive) media information to and from network 560. Content delivery device(s) 540 also may be coupled to platform 502 and/or to display 520.

In various implementations, content services device(s) 530 may include a cable television box, personal computer, network, telephone, Internet enabled devices or appliance capable of delivering digital information and/or content, and any other similar device capable of unidirectionally or bidirectionally communicating content between content providers and platform 502 and/display 520, via network 560 or directly. It will be appreciated that the content may be communicated unidirectionally and/or bidirectionally to and from any one of the components in system 500 and a content provider via network 560. Examples of content may include any media information including, for example, video, music, medical and gaming information, and so forth.

Content services device(s) 530 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 502 may receive control signals from navigation controller 550 having one or more navigation features. The navigation features of controller 550 may be used to interact with user interface 522, for example. In various embodiments, navigation controller 550 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 550 may be replicated on a display (e.g., display 520) by movements of a pointer, cursor, focus ring, or other visual indicators displayed on the display. For example, under the control of software applications 516, the navigation features located on navigation controller 550 may be mapped to virtual navigation features displayed on user interface 522, for example. In various embodiments, controller 550 may not be a separate component but may be integrated into platform 502 and/or display 520. The present disclosure, however, is not limited to the elements or in the context shown or described herein.

In various implementations, drivers (not shown) may include technology to enable users to instantly turn on and off platform 502 like a television with the touch of a button after initial boot-up, when enabled, for example. Program logic may allow platform 502 to stream content to media adaptors or other content services device(s) 530 or content delivery device(s) 540 even when the platform is turned “off” In addition, chipset 505 may include hardware and/or software support for 5.1 surround sound audio and/or high definition 7.1 surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 500 may be integrated. For example, platform 502 and content services device(s) 530 may be integrated, or platform 502 and content delivery device(s) 540 may be integrated, or platform 502, content services device(s) 530, and content delivery device(s) 540 may be integrated, for example. In various embodiments, platform 502 and display 520 may be an integrated unit. Display 520 and content service device(s) 530 may be integrated, or display 520 and content delivery device(s) 540 may be integrated, for example. These examples are not meant to limit the present disclosure.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 502 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

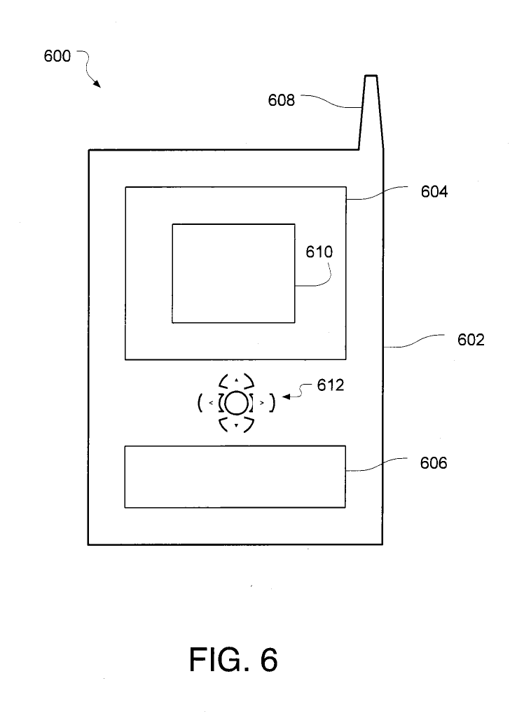

As described above, system 500 may be embodied in varying physical styles or form factors. FIG. 6 illustrates implementations of a small form factor device 600 in which system 500 may be embodied. In various embodiments, for example, device 600 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may include a housing 602, a display 604, an input/output (I/O) device 606, and an antenna 608. Device 600 also may include navigation features 612. Display 604 may include any suitable display unit for displaying information, in, for example, a Graphical User Interface (GUI) 610, appropriate for a mobile computing device. I/O device 606 may include any suitable I/O device for entering information into a mobile computing device. Examples for I/O device 606 may include an alphanumeric keyboard, a numeric keypad, a touch pad, input keys, buttons, switches, rocker switches, microphones, speakers, voice recognition device and software, and so forth. Information also may be entered into device 600 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

In accordance with the present disclosure, automated collaborative media gathering systems may include a first module to determine a goal for collaborative media gathering and a second module to automatically generate a plurality of tasks specifying the capture of media associated with the goal, to store the tasks in memory, and to provide the tasks to a plurality of users. The first module may receive user feedback from at least one of the users, wherein the user feedback includes information specifying at least one of a current status of at least one task being performed by the user, one or more additional tasks to be associated with the goal, or a modification to be applied to one or more of the tasks. In some examples, the first module may receive the user feedback in real-time over at least one network. In some examples, to automatically generate the tasks the second module may perform at least one of a visual media processing algorithm, an audio and speech processing algorithm, a social media analysis and natural language processing algorithm, or a machine learning and statistical analysis algorithm. In some examples, the second module may provide the tasks to the plurality of users over a peer-to-peer network.

In accordance with the present disclosure, automated collaborative media gathering systems may further include a third module to receive media captured by at least one of the plurality of users in response to at least one of the tasks. In some examples, the second module may automatically generate one or more additional tasks in response to the captured media. In some examples, to determine the goal the first module may automatically determine the goal in response to real-time social media analysis. In some examples, to determine the goal the first module may determine the goal in response to at least one of the users.

In accordance with the present disclosure, automated collaborative media gathering methods may include determining a goal for collaborative media gathering, automatically generating a plurality of tasks specifying the capture of media associated with the goal, storing the tasks, and providing the tasks to a plurality of users. The goal may be automatically determined in response to real-time social media analysis. The methods may also include receiving user feedback from at least one of the users, where the user feedback includes information specifying at least one of a current status of at least one task being performed the user, one or more additional tasks to be associated with the goal, or a modification to be applied to one or more of the tasks. The user feedback may be received in real-time over at least one network. Automatically generating the plurality of tasks may include performing at least one of a visual media processing algorithm, an audio and speech processing algorithm, a social media analysis and natural language processing algorithm, or a machine learning and statistical analysis algorithm.

In accordance with the present disclosure, the methods may further include receiving media captured by at least one of the plurality of users in response to at least one of the tasks, and automatically generating one or more additional tasks in response to the captured media. The methods may also include updating at least one of the goal or tasks in response to user feedback.

What is claimed:

1. A system for automated collaborative media gathering, comprising:
a first module to determine a goal for collaborative media gathering; and
a second module to automatically generate a plurality of tasks specifying the capture of media associated with the goal, to store the tasks in memory, and to provide the tasks to a plurality of users.

2. The system of claim 1, wherein the first module is to receive user feedback from at least one of the users, wherein the user feedback comprises information specifying at least one of a current status of at least one task being performed by the user, one or more additional tasks to be associated with the goal, or a modification to be applied to one or more of the tasks.

3. The system of claim 2, wherein the first module is to receive the user feedback in real-time over at least one network.

4. The system of claim 1, wherein the second module is to provide the tasks to the plurality of users over a peer-to-peer network.

5. The system of claim 1, wherein to automatically generate the tasks the second module is to perform at least one of a visual media processing algorithm, an audio and speech processing algorithm, a social media analysis and natural language processing algorithm, or a machine learning and statistical analysis algorithm.

6. The system of claim 1, further comprising:
a third module to receive media captured by at least one of the plurality of users in response to at least one of the tasks.

7. The system of claim 6, wherein the second module is to automatically generate one or more additional tasks in response to the captured media.

8. The system of claim 1, wherein to determine the goal the first module is to automatically determine the goal in response to real-time social media analysis.

9. The system of claim 1, wherein to determine the goal the first module is to determine the goal in response to at least one of the users.

10. An automated collaborative media gathering method comprising:
determining a goal for collaborative media gathering;
automatically generating a plurality of tasks specifying the capture of media associated with the goal;
storing the tasks; and
providing the tasks to a plurality of users.

11. The method of claim 10, further comprising receiving user feedback from at least one of the users, wherein the user feedback comprises information specifying at least one of a current status of at least one task being performed by the user, one or more additional tasks to be associated with the goal, or a modification to be applied to one or more of the tasks.

12. The method of claim 11, wherein receiving the user feedback comprises receiving, in real-time over at least one network, the user feedback from at least one of the users.

13. The method of claim 10, wherein providing the tasks to the plurality of users comprises providing the tasks over a peer-to-peer network.

14. The method of claim 10, wherein automatically generating the plurality of tasks comprises performing at least one of a visual media processing algorithm, an audio and speech processing algorithm, a social media analysis and natural language processing algorithm, or a machine learning and statistical analysis algorithm.

15. The method of claim 10, further comprising receiving media captured by at least one of the plurality of users in response to at least one of the tasks.

16. The method of claim 15, further comprising automatically generating one or more additional tasks in response to the captured media.

17. The method of claim 10, wherein determining the goal comprises automatically determining the goal in response to real-time social media analysis.

18. The method of claim 10, wherein determining the goal comprises setting the goal in response to at least one of the users.

19. The method of claim 10, further comprising updating at least one of the goals or tasks in response to user feedback.

20. An article comprising one or more computer program products having stored therein instructions that, if executed, result in:
determining a goal for collaborative media gathering;
automatically generating a plurality of tasks specifying the capture of media associated with the goal;
storing the tasks; and
providing the tasks to a plurality of users.

21. The article of claim 20, further comprising receiving user feedback from at least one of the users, wherein the user feedback comprises information specifying at least one of a current status of at least one task being performed by the user, one or more additional tasks to be associated with the goal, or a modification to be applied to one or more of the tasks.

22. The article of claim 21, wherein receiving the user feedback comprises receiving, in real-time over at least one network, the user feedback from at least one of the users.

23. The article of claim 20, wherein providing the tasks to the plurality of users comprises providing the tasks over a peer-to-peer network.

24. The article of claim 20, wherein automatically generating the plurality of tasks comprises performing at least one of a visual media processing algorithm, an audio and speech processing algorithm, a social media analysis and natural language processing algorithm, or a machine learning and statistical analysis algorithm.

25. The article of claim 20, further comprising receiving media captured by at least one of the plurality of users in response to at least one of the tasks.

26. The article of claim 25, further comprising automatically generating one or more additional tasks in response to the captured media.

27. The article of claim 20, wherein determining the goal comprises automatically determining the goal in response to real-time social media analysis.

28. The article of claim 20, wherein determining the goal comprises setting the goal in response to at least one of the users.

29. The article of claim 20, further comprising updating at least one of the goals or tasks in response to user feedback.
